(19) United States
(12) Patent Application Publication
(10) Pub. No.: US 2018/0141038 A1
(43) Pub. Date: May 24, 2018

(54) SINGLE CARTRIDGE FOR MULTIPLE DETECTION MODALITIES

(71) Applicant: KONINKLIJKE PHILIPS N.V., EINDHOVEN (NL)

(72) Inventors: PIETER JAN VAN DER ZAAG, WAALRE (NL); JACOBUS HERMANUS MARIA NEIJZEN, HEEZE (NL); MENNO PRINS, EINDHOVEN (NL); JEROEN HANS NIEUWENHUIS, WAALRE (NL); TOON HENDRIK EVERS, EINDHOVEN (NL); ALOYSIUS CORNELIS JOHANNES STROUCKEN, EINDHOVEN (NL)

(21) Appl. No.: 15/564,004

(22) PCT Filed: Apr. 8, 2016
(86) PCT No.: PCT/EP2016/057676

§ 371 Date: Oct. 3, 2017

(30) Foreign Application Priority Data
Apr. 8, 2015 (EP) 15162785.8

(51) Int. Cl. B01L 3/00

(52) U.S. Cl. CPC B01L 3/502; B01L 2200/0621; B01L 2200/0668; B01L 2400/0694; B01L 2200/143; B01L 2400/049; B01L 2400/0406

(57) ABSTRACT

The present invention relates to a sensor cartridge (100) comprising: a sample depot (10) which is configured to store a liquid sample; a first cartridge portion (20) comprising a first measurement chamber (22) which is coupled to the sample depot (10) and configured to receive a quantity of the liquid sample from the sample depot (10), wherein the first cartridge portion (20) is configured to measure a first analyte using a first modality on the quantity of the liquid sample and to provide a first analyte test signal; a cartridge portion (30-1) comprising a second measurement chamber (32-1) which is coupled to the first measurement chamber (20), which is configured to receive the quantity of the liquid sample from the first measurement chamber (22), wherein the cartridge portion (30) is configured to measure a second analyte using a second modality on the quantity of the liquid sample and to provide a second analyte test signal.

### FIELD OF THE INVENTION

The present invention relates to cartridges for multiple detection modalities. In particular, the present invention relates to a sensor cartridge for liquid analysis and a method for liquid analysis.

### BACKGROUND OF THE INVENTION

Point-of-Care, POC, testing offers the opportunity to test patients and to perform the necessary diagnosis or monitoring of a patient on the spot and to determine the appreciate action without having to send the patient to a hospital.

U.S. Pat. No. 7,604,592 B2 discloses a method and an apparatus for a Point-of-Care device. A plurality of Point-of-Care, POC, tests on a single cartridge is provided such that the sequential or non-sequential tests may be performed in an integrated fashion without changing the test cartridge. Each cartridge contains a penetrating member sensor combination in a radial disk format, interrogated and read by a single illumination/cartridge portion. The series of tests can be measured electrochemically and reported.

### SUMMARY OF THE INVENTION

There may be a problem of test cartridges to provide multiple types of tests in a single cartridge from a single blood sample.

These needs are met by the subject-matter of the independent claims. Further exemplary embodiments are evident from the dependent claims and the following description.

An aspect of the present invention relates to a cartridge, for example a sensor cartridge for liquid analysis, the sensor cartridge comprising: a sample depot which is configured to store a liquid sample; a first cartridge portion comprising a first measurement chamber which is connected to the sample depot and configured to receive a quantity of the liquid sample from the sample depot, wherein a first analyte is measured in the first measurement chamber using a first modality on the quantity of the liquid sample and wherein a first analyte test signal is obtained; a second cartridge portion comprising a second measurement chamber which is connected to the first cartridge portion and which is configured to receive a quantity of the liquid sample from the first measurement chamber, wherein a second analyte is measured using a second modality on the quantity of the liquid sample and wherein a second analyte test signal is obtained.

According to a further, second aspect of the present invention, the use of the sensor cartridge according to the first aspect or according to any implementation form of the first aspect is provided.

A further, third aspect of the present invention provides a method for liquid analysis, the method comprising the following steps of: storing a liquid sample in a sample depot; receiving a quantity of the liquid sample from the sample depot in a first cartridge portion comprising a first measurement chamber and measuring a first analyte using a first modality on the quantity of the liquid sample by the first cartridge portion and providing a first analyte test signal by the first cartridge portion; receiving the quantity of the liquid sample from the first measurement chamber in a second cartridge portion and measuring a second analyte using a second modality on the quantity of the liquid sample by the second cartridge portion and providing a second analyte test signal by the second cartridge portion; and determining a first output for the first modality based on the first analyte test signal and/or the second analyte test signal by a read-out controller and determining a second output for the second modality based on the first analyte test signal and/or the second analyte test signal by the read-out controller.

A fourth aspect of the present invention provides a reader device for receiving a cartridge according to the first aspect of the present invention or according to any implementation form of the first aspect, the analyser device comprising: a reader to provide an analyte test signal; an actuator configured to drive a quantity of a liquid sample; a read-out controller configured to determine, on a first cartridge portion, a first output of a first detection modality based on a first analyte test signal, and wherein the read-out controller is further configured to drive the quantity of a liquid sample to a second cartridge portion of choice.

A fifth aspect of the present invention provides a system comprising a sensor cartridge, the sensor cartridge comprising: a sample depot which is configured to store a liquid sample; a first cartridge portion comprising a first measurement chamber which is connected to the sample depot and configured to receive a quantity of the liquid sample from the sample depot, a second cartridge portion comprising a second measurement chamber which is connected to the first cartridge portion and which is configured to receive a quantity of the liquid sample from the first measurement chamber, a reader device for receiving the sensor cartridge, the reader device comprising: a reader to provide an analyte test signal; an actuator configured to drive a quantity of a liquid sample to the first cartridge portion and to a second cartridge portion of choice; a read-out controller configured to measure a first analyte in the first measurement chamber using a first modality on the quantity of the liquid sample and wherein a first analyte test signal is obtained; and further configured to measure a second analyte in the second measurement chamber using a second modality on the quantity of the liquid sample and wherein a second analyte test signal is obtained.

In other words, the present invention advantageously allows the reuse of blood samples among the various test modalities in a single cartridge.

The present invention advantageously solves the practical problem of having insufficient sample available, for instance only 5 or 10 or 20 μl of blood, for all multiple tests for cell detection, clinical chemistry or protein assays or any further medical monitoring. The present invention advantageously allows moving the sample from one test or modality to the next test or modality. The present invention may advantageously provide a method to move the sample depending on the concentration of an analyte in the sample or depending on the volume of the sample or depending on the outcome of analyte value.

For instance, the concentration of an analyte may be determined in a first assessment and depending on the determined value further follow-on measurements in other chambers will follow.

The present invention further advantageously allows for instance that the first measurement is used as a calibration for the following second and/or any further measurements.

The present invention proposes to re-use (part of) a blood sample among different detection modalities within a single cartridge.

The present invention further advantageously allows for that data of one detection modality can be used to calibrate/take decision on whether to move to the next modality.

The present invention further advantageously allows moving only certain analytes contained in the sample, for example by means of magnetic selection, or by means of a magneto-capillary valve structure. A magneto-capillary valve is for example a capillary channel, part of a micro fluidic system, in which a valve-like structure allows the passage of magnetic particles, but hinders the passage of fluids. In such structure, it is possible to provide magnetic particles capable of binding a target molecule present in a fluid, so that by means of a magnetic actuator it is possible to move only the target molecules, bound to the magnetic particles, but not the fluid, from one side of the valve to the other. This can be achieved for example by the use of a deformable material and/or by hydrophobic components or modifications in the capillary channel and/or in the valve-like structure.

The present invention further advantageously allows that the sample may be moved between detection modalities in series, or it can be stored in a storage chamber first, and portions of it are moved to the different detection chambers.

The present invention further advantageously allows re-using the sample processed in series and/or in parallel and/or in a combination e.g. using parallel paths in series or vice versa, for instance two MCV processes being run in parallel. The sample may be being re-used, i.e. processed in series. For instance, some part of the processing may be parallel paths in series.

According to an exemplary embodiment of the present invention, the sample depot is configured to store a blood draw as the liquid sample.

According to an exemplary embodiment of the present invention, the sample depot is configured to store as the blood draw a blood amount of up to 80 μl, preferably of up to 20 μl, most preferably of up to 5 μl.

According to an exemplary embodiment of the present invention, the read-out controller is configured to perform a first calibration for the first modality based on the first analyte test signal and to perform a second calibration for the second modality based on the first analyte test signal and the second analyte test signal.

According to an exemplary embodiment of the present invention, the sensor cartridge may comprise a plurality of second cartridge portions and the read-out controller is configured to select at least one second cartridge portion out of the plurality of second cartridge portions.

According to an exemplary embodiment of the present invention, a first, second, and third analysis may be done on the sample or any further analysis. For instance, an analysis of clinical chemistry (Na⁺ and K⁺) may be conducted and then a cell analysis (white blood cell count) may be performed and then finally an immunoassay (to determine CRP level) may be performed.

According to an exemplary embodiment of the present invention, the first output for the first modality may be based on the first analyte test signal and the second analyte test signal by the read-out controller.

According to an exemplary embodiment of the present invention, the read-out controller is configured to select at the least one second cartridge portion based on the first analyte test signal.

According to an exemplary embodiment of the present invention, the read-out controller is configured to select a further cartridge portion based on the second and any other successive analyte test signal.

According to an exemplary embodiment of the present invention, between the first cartridge portion and the second cartridge portion a storage chamber is coupled, which is configured to store the quantity of the liquid sample.

This advantageously allows steering the transport of the liquid sample.

According to an exemplary embodiment of the present invention, the first cartridge portion and/or the second cartridge portion comprise a liquid reservoir, which is configured to provide a reagent for the quantity of the liquid sample. This advantageously allows transporting the quantity of the liquid sample in a safe and secure way.

According to an exemplary embodiment of the present invention, the sensor cartridge is configured to transport the quantity of the liquid sample from the sample depot by capillary forces. This advantageously allows safely and reliably transporting the quantity of the liquid sample.

According to an exemplary embodiment of the present invention, the sensor cartridge is configured to transport the quantity of the liquid sample from the sample depot by vacuum forces. This advantageously allows transporting the quantity of the liquid sample in a precisely adjustable manner.

According to an exemplary embodiment of the present invention, the first cartridge portion and/or the second cartridge portions comprise an actuator, which is configured to transport the quantity of the liquid sample. This advantageously allows an efficient moving and transport of the quantity of the liquid sample.

According to an exemplary embodiment of the present invention, the sensor cartridge is configured be used for a point of care application.

These and other aspects of the present invention will become apparent from and be elucidated with reference to the embodiments described hereinafter.

### BRIEF DESCRIPTION OF THE DRAWINGS

A more complete appreciation of the present invention and the attendant advantages thereof will be more clearly understood by reference to the following schematic drawings, which are not to scale, wherein:

FIG. 1 shows a schematic diagram of a system comprising a sensor cartridge according to an exemplary embodiment of the present invention;

FIG. 2 shows a schematic diagram of a sensor cartridge according to an exemplary embodiment of the present invention;

FIG. 3 shows a schematic diagram of a system comprising a sensor cartridge according to an exemplary embodiment of the present invention;

FIG. 4 shows a schematic flow-chart diagram of a method for liquid analysis according to an exemplary embodiment of the present invention; and

FIG. 5 shows a schematic diagram of cartridge portion according to an exemplary embodiment of the present invention.

### DETAILED DESCRIPTION OF EMBODIMENTS

The illustration in the drawings is purely schematical and does not intend to provide scaling relations or size information. In different drawings or figures, similar or identical elements are provided with the same reference numerals. Generally, identical parts, units, entities or steps are provided with the same reference symbols in the description.

The term “analyte” as used by the present invention, may refer to an analyte, or component (in clinical chemistry), that is a substance or chemical constituent that is of interest in an analytical procedure.

The sensor cartridge according to the embodiments of the present invention may be a multi-analyte biosensor cartridge.

The term “liquid sample” as used by the present invention may refer to a body fluid, bodily fluids, or bio-fluids or any kind of liquids originating, for instance, from inside organs of the human body.

The term “liquid sample” may include fluids or liquids that are excreted or secreted from the body as well as body liquids. For instance, the bodily liquids may contain proteins, enzymes and small molecules for detection.

The terms “blood” and “blood sample” as used by the present invention may refer to full blood, but also to any component thereof, for example, blood plasma, blood serum, etc.

The term “modality” as used by the present invention may refer to a measurement method for the determination of a physical property or quantity of an object or of a chemical compound, for instance a physical property or quantity like sound, temperature, light, or concentration or pressure.

The term “re-used” or “re-using” as used by the present invention may refer to any consecutive performing or taking of measurements with regard to the liquid sample, in other words a measurement or test is performed on a liquid sample on which previously another test or measurement was performed.

The terms “previous, preceding, etc.” or “successive, following, etc.” (and all their synonyms) when referred to a cartridge portion or to any chamber of a cartridge, for example a measurement chamber, indicate a temporal sequence of the position of the liquid sample, namely, the portion or chamber from where the liquid sample is being transported, and the portion or chamber to where the liquid sample will be transported, respectively. These can be predetermined sequences, or sequences decided at the moment, as will be further explained in the present description.

The present invention advantageously solves the practical problem of having insufficient sample available (from a finger prick of blood) for all the various test for cell detection, clinical chemistry and protein assay.

The present invention advantageously provides a solution by moving the sample from one test (modality) to the next based on conditions or criteria. The moving may be done depending on:

the concentration of an analyte (for instance a first assessment of the range of an analyte given analytical performance of follow-on measurement chambers); or

the volume of the liquid sample; or

the outcome, i.e. the result or output signal, of an analyte value which has relevance for the next analyte measurements to be done, given knowledge about certain clinical conditions (this may be connected to/giving rise to so-called clinical decisions support).

The present invention advantageously provides that re-use of the same sample occurs among various detection modalities, which thus far operate in isolation without one receiving (blood) sample input from the other (from the same/single finger prick of blood).

Since the volume of a single finger prick of blood is limited to only about 10 to 45 μl, reuse of the same sample in a second detection modality would be ideal. However, currently this is not possible. Furthermore, red blood cell lysis may be required to be performed prior to protein or white blood cell detection.

Blood cell lysis may also influence the K⁺ level, i.e. the potassium level. Consequently, K⁺ levels need to be determined from plasma prior to red blood cell lysis. This may be effected by siphoning off a small fraction of the blood and extract plasma to do the K⁺ measurement. Afterward the red blood cells may be lysed for white blood cell, WBC, measurement. This may cause a change in the hematocrit value of the liquid sample. In case of performed protein detection, this will change the concentration of a protein of the liquid sample to be measured in plasma as the hematocrit value of blood varies between 36-51% depending on person and sex.

The concentration of a protein in plasma e.g. troponin may change by up to a factor of 2, making the detection of e.g. troponin concentration unreliable, if a lysed sample were to be used again, for the case that data of the first measurement is not used for evaluation or calibration of the second analyte test or measurement.

The present invention advantageously provides a single cartridge that retains the same sample, i.e. re-use of the liquid sample is therefore possible. For instance, the hematocrit value can be measured and the measured value can be used to calibrate the protein detection in any further measurements to be performed.

Re-use of the liquid sample thus enables multiple tests to be done on the same small sample and enables a full blood analysis from a single finger prick of whole blood, using multiple modalities. This enables key developments for the adoption of, for instance, POC testing.

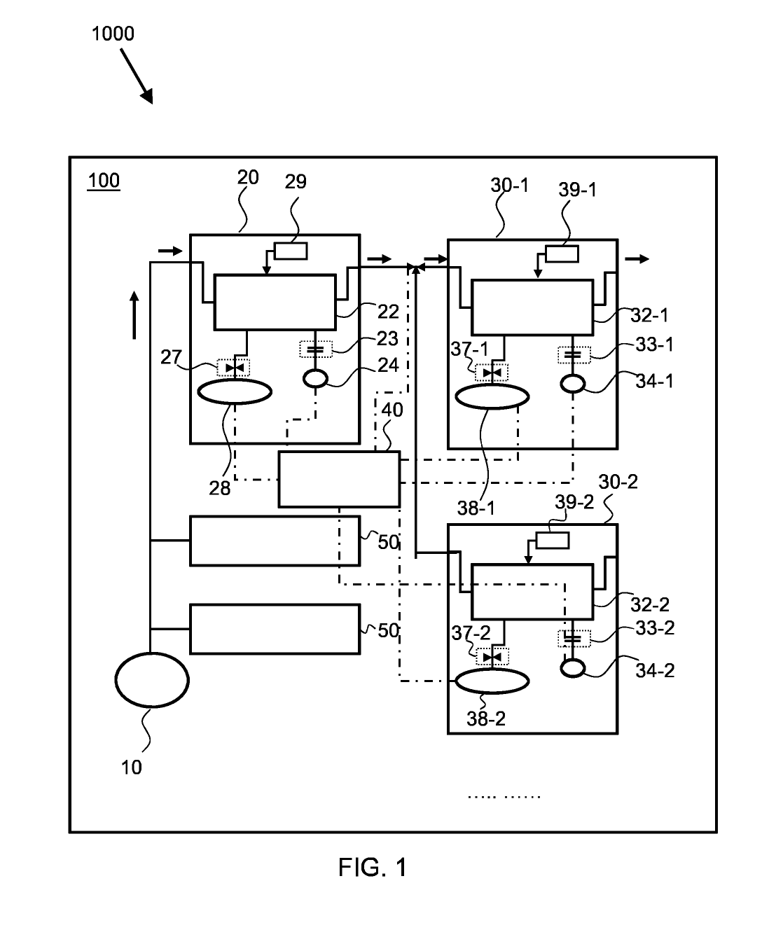

FIG. 1 shows a schematic diagram of a system comprising a sensor cartridge according to an exemplary embodiment of the present invention.

FIG. 1 shows a schematic picture showing a system comprising a sensor cartridge structure, in which a measurement chamber is connected to one detection modality.

The sensor cartridge 100 may comprise a sample depot 10, a first cartridge portion 20, a second cartridge portion 30-1. A system 1000 may comprise the sensor cartridge 100 and a read-out controller 40.

The first cartridge portion 20 may comprise a first measurement chamber 22. The first measurement chamber 22 may be coupled to the sample depot 10. The first measurement chamber 22 may be configured to receive a quantity of the liquid sample from the sample depot 10. The first cartridge portion 20 may be configured to measure a first analyte using a first modality on the quantity of the liquid sample and may be configured to provide a first analyte test signal.

The first cartridge portion 20 may comprise a liquid reservoir 28, for example a pouch, with certain reagents needed for the analysis or the processing of the sample, coupled to the first measurement chamber 22 via a fluidic switch 27. The first cartridge portion 20 may comprise a venting hole 24 that can be pierced to allow a fluid to fill in a chamber between the fluid and the venting hole by capillary force, coupled to the first measurement chamber 22 via a fluidic stop 23.

The second cartridge portion 30-1 may comprise a second measurement chamber 32-1. The second measurement chamber 32-1 may be coupled to the first measurement chamber 22. The second measurement chamber 32-1 may be configured to receive the quantity of the liquid sample from the first measurement chamber 22. The second cartridge portion 30-1 may be configured to measure a second analyte using a second modality on the quantity of the liquid sample and may be configured to provide a second analyte test signal.

The second cartridge portion 30-1 may comprise a liquid reservoir 38-1 such as a pouch containing reagents, coupled to the second measurement chamber 32-1 via a fluidic switch 37-1 and a venting hole 34-1 that can be pierced, coupled to the second measurement chamber 32-1 via a fluidic stop 33-1. The fluidic stop may be, for instance, a Goretex membrane which is permeable for air but not for liquids

The first cartridge portion 20 and/or the second cartridge portion 30-1, . . . , 30-n may be configured to perform the following analyte tests:

i) blood cell testing to check for infections/immune system response via white blood cell count;
ii) protein testing by immuno-assays;
iii) clinical chemistry testing typically by electrochemical techniques; or
iv) molecular diagnostics
v) further biosensor tasks or any other detections of an analyte
vi) cell analysis, e.g. tests for CD4 and/or CD8 cells. In molecular biology, CD4 (cluster of differentiation 4) is a glycoprotein found on the surface of immune cells such as such as T helper cells, monocytes, macrophages.

The read-out controller 40 may be configured to determine a first output for the first modality based on the first analyte test signal and/or the second analyte test signal. The read-out controller 40 may be configured to determine a second output for the second modality based on the first analyte test signal and/or the second analyte test signal. The first output and/or the second output may correspond to a quantity of the analyte as present in the liquid sample.

According to an exemplary embodiment of the present invention, the first output may be determined using the first analyte test signal and the second output may be determined using the first analyte test signal and the second analyte test signal, or vice versa, i.e. the the first output may be determined using the first analyte test signal and the second analyte test signal and the second output may be determined using the second analyte test signal. In other words, at least one output may be determined using a further analyte test signal.

According to an exemplary embodiment of the present invention, the read-out controller 40 may be configured to either determine the first output based on the first analyte test signal and second analyte test signal or to determine the second output based on the first analyte test signal and second analyte test signal.

According to an exemplary embodiment of the present invention, the liquid sample can be transported along the cartridge by capillary flow. The direction of the capillary flow may be governed and controlled by capillary pull as formed by the first cartridge portion 20 and/or the second cartridge portion 30-1, . . . , 30-n. That is the capillary flow may be driven by the increasing capillary pull. This can be effected by reducing the channel height such that the contact-area/volume ratio, and thereby the capillary pull, increases.

According to an exemplary embodiment of the present invention, the liquid sample can follow a predefined path along the different chambers in the cartridge, or it can follow a customizable path. In the latter case, the device in which the cartridge is inserted may have a user interface through which a user can select different measurement menus or set up a customized new measurement menu. For example, the blood sample or the liquid sample may be sent according to a predefined protocol from a first measurement chamber 22 connected to a first detection modality in form of the first cartridge portion 20 to a second measurement chamber 32-1, . . . , 32-n connected to a different detection modality in form of the second cartridge portion 30-1, . . . , 30-n.

According to an exemplary embodiment of the present invention, the sample flow can be steered such that the liquid sample is first sent from the first cartridge portion 20 to a different second cartridge portion, for instance to second cartridge portion 30-2, rather than to second cartridge portion 30-1, or to second cartridge portion 30-1 followed by the second cartridge portion 30-2. Depending on which measurement menu is selected, different venting-hole will be pierced, in order to steer the capillary flow according to the selected measurement menu.

According to an exemplary embodiment of the present invention, the first cartridge portion 20 and/or the second cartridge portion 30-1, . . . , 30-n may comprise an actuator 29-1; 39-1, . . . , 39-n, which is configured to push and/or pull the quantity of the liquid sample.

According to an exemplary embodiment of the present invention, the first cartridge portion 20 and/or the second cartridge portions 30-1, . . . , 30-n may comprise an actuator 29-1; 39-1, . . . , 39-n, which is configured to transport the quantity of the liquid sample.

According to an exemplary embodiment of the present invention, a selection of flow path depends on measurement output of the detection occurring in the first cartridge portion 20. For example, depending on the measurement output obtained from the detection in the first cartridge portion 20, the sample may be sent to either the second measurement chamber 32-1 or the second measurement chamber 32-2.

In other words, different second measurement chambers 32-1, . . . , 32-n may be selected for carrying out further detection modalities, based on the outputs obtained from detection modalities that took place in previous cartridge portions. For example, after obtaining a test signal from a first detection modality in the first cartridge portion, the user may realize that the next detection modality, in a second cartridge portion, would be irrelevant, and he can thus choose to skip said second cartridge portion and direct the blood sample to a further cartridge portion wherein a different detection modality can take place.

It is within the scope of the present invention that any known method to move a liquid along a microfluidic or capillary system may be applied to the present invention in order to transport or drive the liquid sample along the cartridge.

According to an exemplary embodiment, a liquid sample may be driven by a vacuum pump that creates an under pressure in the direction where the liquid is meant to be transported.

According to another exemplary embodiment, a liquid sample may be driven by capillary flow in combination with the piercing of a venting hole, wherein such piercing of a venting hole will let the liquid sample move toward said hole.

According to another exemplary embodiment, a liquid sample may be driven by an actuator, for example by an actuator that would press against a liquid reservoir, in form of a pouch, so as to force the liquid out of said pouch.

According to an exemplary embodiment of the present invention, the read-out controller 40 may be configured to determine a routing and re-using the sample along the various detecting modalities.

The sensor cartridge 100 may comprise further cartridge portions 50, coupled to the sample depot 10 as shown in FIG. 1, or to the first cartridge portion 20, or to the second cartridge portion 30-1, . . . , 30-n.

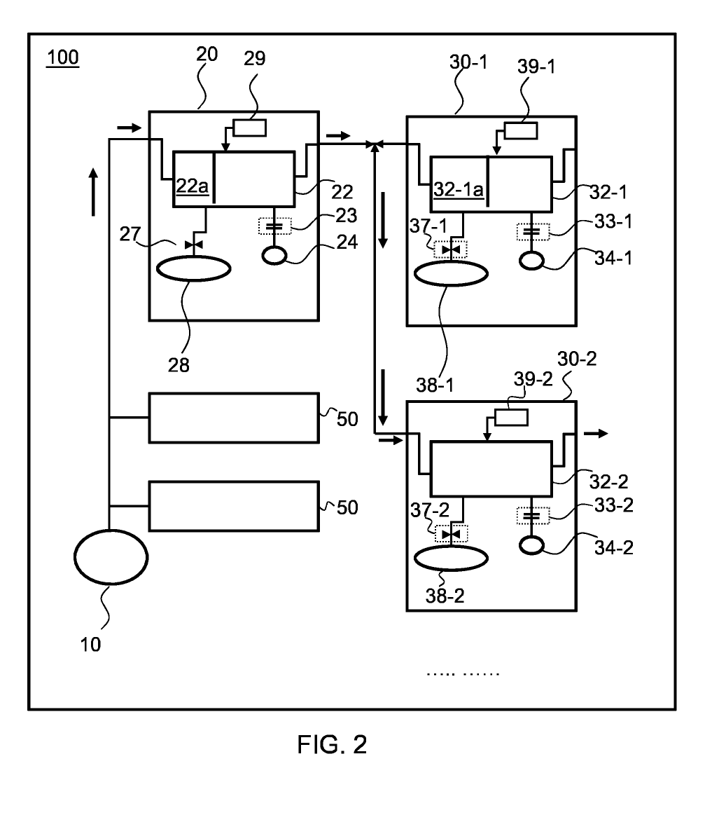

FIG. 2 shows a schematic diagram of a sensor cartridge according to an exemplary embodiment of the present invention.

In contrast to FIG. 1, FIG. 2 shows a schematic picture showing the sensor cartridge 100 which comprises a plurality of second cartridge portions 30-1, . . . 30-n. A readout controller 40 may be coupled to the sensor cartridge 100 and may be configured to select at least one second cartridge portion 30-2 out of the plurality of second cartridge portions 30-1, 30-2. The selected second cartridge portion 30-2 is then provided with the quantity of the liquid sample, which was previously used in the first cartridge portion 20. The advantage of this approach may be regarded as that the the quantity of the liquid sample may be directed or steered to a specific measurement chamber used for specific follow-on measurements. This may depend on the result of the first measurements as performed in the first cartridge portion 20.

In a further modification the application of reagents may be done in a storage chamber 22a, 32-1a, 32-2a . . . , which may be a subsection of the measurement chamber 22, 32-1, 32-2 . . . , when doing this in the measurement chamber may disturb the measurements.

According to an exemplary embodiment of the present invention, in case that the liquid sample is a blood sample, thus including red blood cells, a Hemoglobin (Hb) measurement is performed in the first chamber, for example by optical absorption. Subsequently, the plasma fraction may be extracted by driving the sample through a filter or pillar structure, and subsequently K+ is measured in the remaining plasma fraction.

According to another embodiment, following Hb measurement, chemical lysis reagents may be added to the storage chamber to lyse the red blood cell and perform a white blood cell count. After the lysis, the sample can be transported to a second cartridge portion, where an immunoassay can be performed in the lysed blood in order to measure the concentration of a target protein, for example Troponin or CRP (C-reactive Protein). According to this embodiment, the previously obtained Hb concentration can be used to calibrate the data obtained from said immunoassay; Hb measurement, in fact, is correlated to the hematocrit, i.e. the concentration of red blood cells in the total blood volume. Lysed blood volume comprises the blood plasma volume before the lysis, and the total amount of fluid which was comprised in the red blood cells before the lysis. Since the concentration of a target protein in blood should be based on the plasma volume and not on the lysed blood volume, the Hb measurement can be used to estimate the red blood cell component of the total lysed blood volume, and use this measure to adjust or calibrate the measured target protein concentration. According to this embodiment, it is thus possible to perform a complete set of tests on blood, for example according to three different common modalities, on the same blood droplet and on the same cartridge, wherein the different modalities can be used in a synergistic way in order to optimize the precision of the results. In the aforementioned embodiment, the blood sample is tested according to three modalities:

blood cells count by optical absorption;

Protein concentration measurement by Immunoassay;

Clinical chemistry.

However, it is within the scope of the present invention to have a cartridge comprising more than three chambers for performing more than three different modalities of measurement, or wherein the same modality is used in more than one chamber, for example to measure the concentration of two different proteins.

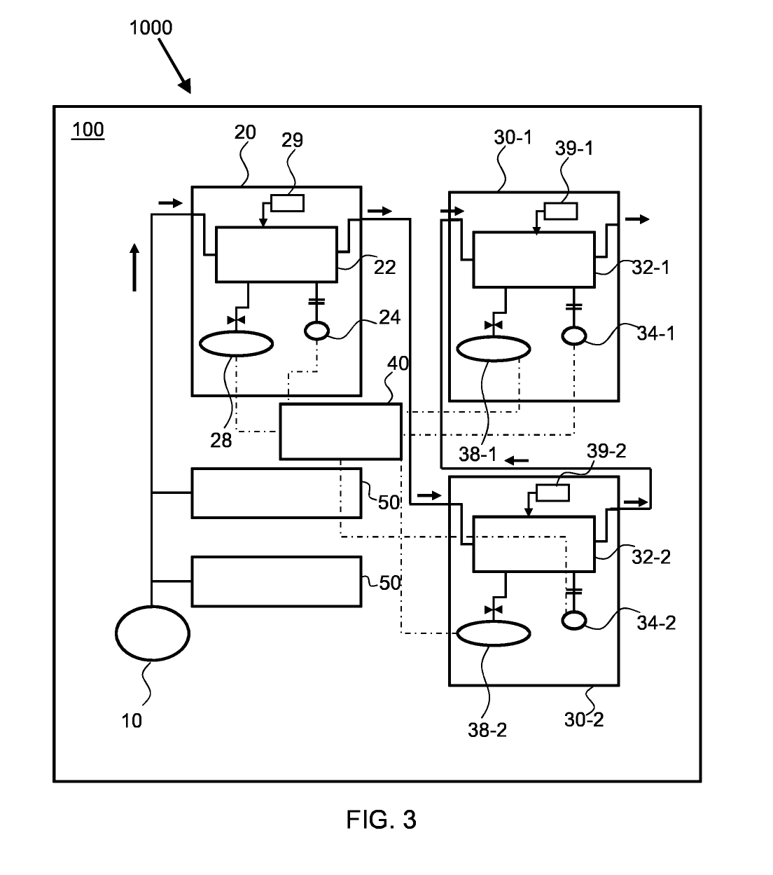

The further reference signs as present in FIG. 3 were already described in the description with respect to FIG. 1.

FIG. 3 shows a schematic diagram of a sensor cartridge according to an exemplary embodiment of the present invention.

In contrast to FIG. 1, FIG. 3 shows a schematic picture showing a cartridge structure in which the sample is transferred to a storage chamber from which it may go to another measurement chamber.

The advantage of this approach may be regarded as that the sample may be held in a chamber free from contaminants such as additional reagents needed, during the time that the results of the analysis in an earlier chamber are performed. In this case the reservoir with reagent has to be seen to be optional for the storage chamber.

According to an exemplary embodiment of the present invention, the application of reagents may be done in a storage chamber, when doing this in the measurement chamber may disturb the measurements.

The further reference signs as present in FIG. 3 were already described in the description with respect to FIG. 1.

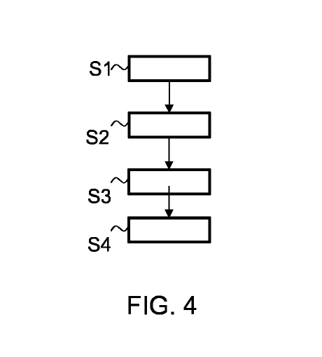

FIG. 4 shows a schematic flow-chart diagram of a method for liquid analysis according to an exemplary embodiment of the present invention.

As a first step of the method, storing S1 a liquid sample in a sample depot 10 may be performed.

As a second step of the method, transferring S2 a quantity of the liquid sample from the sample depot 10 in a first cartridge portion 20 is performed, the first cartridge portion 20 comprising a first measurement chamber 22. Further, measuring a first analyte using a first modality on the quantity of the liquid sample is performed by the first cartridge portion 20 and providing a first analyte test signal by the first cartridge portion 20 is performed as well.

As a third step of the method, transferring S3 the quantity of the liquid sample from the first measurement chamber 22 in a second measurement chamber 32-1 is performed. Further, measuring a second analyte using a second modality on the quantity of the liquid sample is performed by the second cartridge portion 30-1, . . . , 30-n. Further, providing a second analyte test signal by the second cartridge portion 30-1, . . . , 30-n is performed.

As a fourth step of the method, determining S4 a first output for the first modality based on the first analyte test signal and/or the second analyte test signal by a readout controller 40 is performed. Further, determining a second output for the second modality based on the first analyte test signal and/or the second analyte test signal by the read-out controller 40 is performed.

The first analyte test signal may be used as a calibration for the second modality and vice versa. In other words, a determining of the second output for the second modality may be based on the first analyte test signal and the second analyte test signal as performed by the read-out controller 40.

According to an exemplary embodiment of the present invention, different types of magnetic particles may be used to collect a specific analyte of interest from the blood stored in the reservoir. Magnetic particles can be used to extract an analyte of interest from the sample and to transport the analyte of interest to one or more adjacent measurement chambers.

According to an exemplary embodiment of the present invention, magnetic beads may be used to capture a certain molecule of interest, such as a protein, by coating or covering the beads with antibodies or any other protein-binding molecule) or a nucleic acid (e.g. DNA, RNA), by electrostatic binding (such as effected by Dynal beads, for example) after which a clinical chemistry reading is performed on the remaining sample.

According to an exemplary embodiment of the present invention, a multiplexed signal from the same modality may be generated; e.g. use the same sample for multiple immunoassay readings which could be achieved.

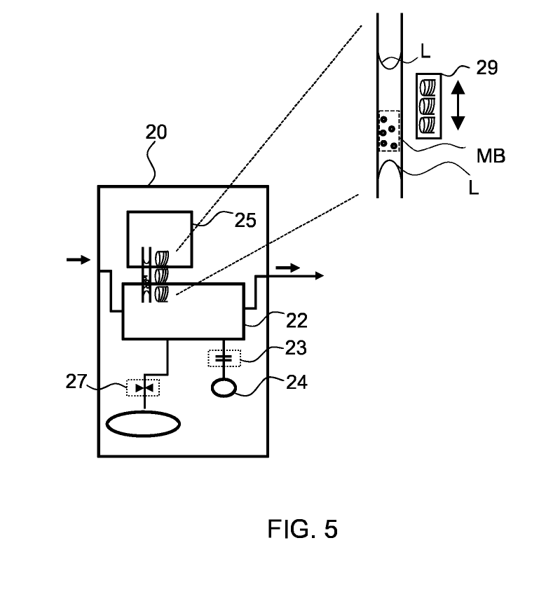

FIG. 5 shows a schematic diagram of cartridge portion according to an exemplary embodiment of the present invention.

According to an exemplary embodiment of the present invention, a magnetic actuating means is shown in FIG. 5 comprising an actuator 29 which is configured to transport a cluster of magnetic beads with a minimal quantity of the liquid sample from a primary measurement chamber 22 to a secondary measurement chamber 25 using magnetic forces. The MCV is the bridge between the primary measurement chamber 22 and the secondary measurement chamber 25. The actuators 29 may comprise electromagnets and the liquids L involved may comprise magnetic beads MB. The magnetic beads are prepared such that they capture a certain molecule from the sample in the primary measurement chamber and transport it through the MCV to the secondary measurement chamber. On the upper right side of FIG. 5, a magnified illustration of the actuator comprising electromagnets is depicted.

The original sample itself can in the meantime be shifted to the next measurement chamber 32-1 by the capillary or other fluid transport methods described earlier where other beads remove another analyte etc by the second actuator 29.

According to an exemplary embodiment of the present invention, the bulk (from which a certain molecule has been removed and transported to the secondary chamber 25) of the sample is reused. Transport of a target analyte to a secondary measurement chamber can be done to simply remove said analyte from the bulk of the sample, or for isolating said analyte from the bulk and perform a separate measurement on it. In addition, it is time-efficient because the measurement of the analytes in the secondary measurement chambers can take place more or less in parallel while the sample itself has been shifted already to the next modality.

The further reference signs as present in FIG. 5 were already described in the description with respect to FIG. 1.

It has to be noted that embodiments of the present invention are described with reference to different subject-matters. In particular, some embodiments are described with reference to method type claims whereas other embodiments are described with reference to the device type claims.

However, a person skilled in the art will gather from the above and the foregoing description that, unless otherwise notified, in addition to any combination of features belonging to one type of the subject-matter also any combination between features relating to different subject-matters is considered to be disclosed within this application.

However, all features can be combined providing synergetic effects that are more than the simple summation of the features.

While the present invention has been illustrated and described in detail in the foregoing description and the drawings, such illustration and description are to be considered illustrative or exemplary and not restrictive; the present invention is not limited to the disclosed embodiments. Other variations to the disclosed embodiments can be understood and effected by those skilled in the art and practicing the claimed invention, from a study of the drawings, the disclosure, and the appended claims.

In the claims, the word “comprising” does not exclude other elements or steps, and the indefinite article “a” or “an” does not exclude a plurality. A single processor or controller or other unit may fulfill the functions of several items recited in the claims. The mere fact that certain measures are recited in mutually different dependent claims does not indicate that a combination of these measures cannot be used to advantage. Any reference signs in the claims should not be construed as limiting the scope.

1. A system comprising:
a sensor cartridge, the sensor cartridge comprising:
a sample depot which is configured to store a liquid sample;
a first cartridge portion comprising a first measurement chamber which is connected to the sample depot and configured to receive a quantity of the liquid sample from the sample depot,
a second cartridge portion comprising a second measurement chamber which is connected to the first cartridge portion and which is configured to receive a quantity of the liquid sample from the first measurement chamber,
a reader device for receiving the sensor cartridge, the reader device comprising:
a reader to provide a first analyte test signal from the first cartridge portion and/or a second analyte test signal from the second cartridge portion;
an actuator configured to drive a quantity of a liquid sample to the first cartridge portion and to a second cartridge portion of choice;
a read-out controller configured to measure a first analyte in the first measurement chamber using a first modality on the quantity of the liquid sample; and further configured to measure a second analyte in the second measurement chamber using a second modality on the quantity of the liquid sample;
wherein the read-out controller is configured to perform a first calibration for the first modality based on the first analyte test signal and/or the second analyte test signal and to perform a second calibration for the second modality based on the first analyte test signal and/or the second analyte test signal.

2. System according to claim 1,
wherein the sensor cartridge comprises a plurality of second cartridge portions and the read-out controller is configured to select at least one second cartridge portion out of the plurality of second cartridge portions.

3. System according to claim 1,
wherein the read-out controller is configured to select at the least one second cartridge portion based on the first analyte test signal.

4. System according to claim 1,
wherein the sample depot is configured to store a blood draw as the liquid sample.

5. System according to claim 4,
wherein the sample depot is configured to store a blood amount of up to 80 μl, preferably of up to 20 μl, most preferably of up to 5 μl.

6. System according to claim 1,
wherein a storage chamber is fluidicly coupled between the first detection cartridge portion and the second cartridge portion, wherein the storage chamber is configured to store the quantity of the liquid sample.

7. System according to claim 1,
wherein the first cartridge portion and/or the second cartridge portion comprise a liquid reservoir comprising a reagent for the quantity of the liquid sample.

8. System according to claim 1,
wherein the sensor cartridge is configured to transport the quantity of the liquid sample from the sample depot by capillary forces.

9. System according to claim 1,
wherein the sensor cartridge is configured to transport the quantity of the liquid sample from the sample depot by vacuum forces.

10. System according to claim 1,
wherein sensor cartridge is a point of care cartridge.

11. A method for liquid analysis comprising:
storing a liquid sample in a sample depot;
receiving a quantity of the liquid sample from the sample depot in a first cartridge portion comprising a first measurement chamber and measuring a first analyte using a first modality on the quantity of the liquid sample by the first cartridge portion and providing a first analyte test signal by the first cartridge portion;
receiving the quantity of the liquid sample from the first measurement chamber in a second measurement chamber and measuring a second analyte using a second modality on the quantity of the liquid sample by a second cartridge portion and providing a second analyte test signal by the second cartridge portion; and
determining a first output for the first modality based on the first analyte test signal and/or the second analyte test signal by a read-out controller and determining a second output for the second modality based on the first analyte test signal and/or the second analyte test signal by the read-out controller,
wherein the first analyte test signal is used as a calibration for the following second and/or any further analyte test signal.

12. Method according to claim 11,
wherein a blood draw is used as the liquid sample comprising a blood amount of up to 80 μl, preferably of up to 20 μl, most preferably of up to 5 μl.
